(19) United States
(12) Patent Application Publication
(10) Pub. No.: US 2002/0161588 A1
(43) Pub. Date: Oct. 31, 2002

(54) Filter/controller callbacks in an embedded audio layer

(75) Inventors: Joseph Camosy, West Palm Beach, FL (US); Gary R. Hanson, Palm Beach Gardens, FL (US); Brien H. Muschett, Palm Beach Gardens, FL (US); Harvey M. Ruback, Loxahatchee, FL (US); Steven G. Woodward, Boca Raton, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/791,960

(22) Filed: Feb. 23, 2001

(51) Int. Cl. G10L 19/00

(52) U.S. Cl. 704/500

(57) ABSTRACT

A system configured to automatically modify audio data and audio device behavior can include an embedded audio layer (EAL), the EAL providing an abstracted interface to an audio device; a filter/controller linked list accessible by the EAL; and, a registration processor for registering filter/controllers (FCs) with the EAL, the registration processor inserting an FC reference into the filter/controller linked list upon registration of a corresponding FC. The system can further include an unregistration processor for unregistering FCs with the EAL, the unregistration processor removing an FC reference from the filter/controller linked list upon unregistration of a corresponding FC. Finally, the system can include an enablement processor for enabling use of a corresponding FC when a specified audio device is active; and, a disablement processor for disabling use of an enabled FC when a specified audio device is active.

### BACKGROUND OF THE INVENTION

1. Technical Field

This invention relates to the field of embedded systems and more particularly to an embedded audio device abstraction layer.

2. Description of the Related Art

Embedded hardware platforms containing audio subsystems can be used by mobile application developers to provide speech technology to mobile devices such as vehicle computers, personal digital assistants (PDAs) and smart phones. Mobile applications incorporating speech technology can allow end-users to have voice activated access to information from work, home, school or while traveling. Important to the development of speech enabled mobile applications is an Embedded Audio Layer (EAL) which can insulate the developer from the complexities of the audio subsystems incorporated in embedded hardware platforms. In particular, the EAL can provide a uniform interface to an audio subsystem which can facilitate the development of mobile speech applications. More particularly, the uniform interface can include functionality for starting an audio device, reading audio data from the audio device, and writing data to the audio device.

Presently, prior to reading data from an audio device through an EAL, it can be advantageous to pre-process the audio data before passing it to an application. Likewise, before writing data to an audio device through an EAL, it can be advantageous to post-process the data after receiving it from an application. The processing of audio data typically can be performed in a filter. An example of a filter is a low-pass filter that eliminates higher frequency content from an audio stream. It also can be advantageous to modify the device behavior of the audio device based on the audio data read from or written thereto. The modification of device behavior can be performed by a controller. Controllers modify audio device behavior by analyzing audio data and executing EAL functions for controlling the audio device. Unlike filters, controllers do not modify audio data.

In conventional systems, while filters can process audio data subsequent to a reading operation and prior to a writing operation, both must occur at the application level outside the reading and writing process as controlled by the EAL. Similarly, in conventional systems while controllers can modify the behavior of an audio device subsequent to a reading operation and prior to a writing operation, both must occur at the application level outside the reading and writing process as controlled by the EAL. Importantly, the integration of a third-party external filter or controller (FC) with the EAL can be a daunting task. Typically, FCs are platform specific and require the FC developer to have intimate knowledge of the audio device characteristics. Finally, the application programming interface (API) from FC to FC can vary dramatically depending upon the developer and the audio device. Hence, what is needed is a simple, pre-constructed, platform-independent mechanism which can allow the automatic modification of audio data or audio device behavior based on characteristics of the audio data read from or written to an audio device.

### SUMMARY OF THE INVENTION

What has been invented is a simple, pre-constructed, platform-independent mechanism which can allow the automatic modification of audio data or audio device behavior based on the audio data read from or written to the audio device immediately before or immediately after the processing of the audio data by the audio device. In particular, a system configured to automatically modify audio data and audio device behavior can include an embedded audio layer (EAL), the EAL providing an abstracted interface to an audio device; a filter/controller linked list accessible by the EAL; and, a registration processor for registering filter/controllers (FCs) with the EAL, the registration processor inserting an FC reference into the filter/controller linked list upon registration of a corresponding FC. The system can further include an unregistration processor for unregistering FCs with the EAL, the unregistration processor removing an FC reference from the filter/controller linked list upon unregistration of a corresponding FC. Finally, the system can include an enablement processor for enabling use of a corresponding FC when a specified audio device is active; and, a disablement processor for disabling use of an enabled FC when a specified audio device is active.

A system for automatically modifying audio data and audio device behavior also can include an EAL; and, at least FC registered with the EAL for automatically modifying audio data and audio device behavior. In one aspect of this system, the FC can be an audio filter programmed to modify audio data. Alternatively, in another aspect of this system, the FC can be an audio device controller programmed to modify audio device behavior. Notably, the system can include a filter/controller linked list containing a reference to at least one registered FC. In particular, each reference in the filter/controller linked list can be a filter/controller linked list data structure which can include an address to a callback to a corresponding registered FC. The filter/controller linked list data structure further can include an address to a callback to an error handling routine associated with the corresponding registered FC. Finally, the filter/controller linked list data structure can further include a flag indicating whether the FC is enabled or disabled.

An FC configured for integration with an EAL can include an entry routine for managing registration and unregistration of the FC; a registration routine for registering the FC with the EAL; an unregistration routine for un-registering the FC with the EAL; and, an FC callback for performing one of modifying audio data and modifying audio device behavior. The FC further can include an error handling callback for handling errors encountered by the FC. Finally, the FC can also include an enablement routine for enabling the FC when registered; and, a disablement routine for disabling an enabled FC.

A method for configuring an EAL to automatically modify audio data and audio device behavior can include receiving a FC reference in the EAL; searching a filter/controller linked list for the FC reference; and, if the FC reference is not found in the filter/controller linked list, inserting a reference to the FC in the filter/controller linked list, the inserted reference having at least one pointer to a callback associated with the FC. Notably, the step of searching the filter/controller linked list for the FC reference can include searching the filter/controller linked list for a match pair comprising an FC identifier for an instance of an FC associated with the reference, and an address for an FC entry routine associated with the reference.

A method for automatically modifying audio data and audio device behavior can include (a) loading a buffer with audio data; (b) retrieving an FC from a filter/controller linked list in an EAL; (c) executing an FC callback associated with the retrieved FC; and, (d) repeating steps (b) and (c) for each FC in the filter controller linked list. The method further can include reloading the buffer with more audio data; and, repeating steps (b) through (d) for the reloaded buffer.

Notably, in one aspect of the present invention, the method can also include determining whether the FC is an audio filter or an audio controller. In that case, the executing step can include, if the FC is an audio filter, executing an audio filter callback, the audio filter callback modifying the audio data in the buffer. Alternatively, the executing step can include, if the FC is an audio controller, executing an audio controller callback, the audio controller callback modifying audio device behavior of a specified audio device.

In one aspect of the invention, the method can further include determining whether the FC is enabled; and, performing the executing step only if the FC is enabled. In another aspect of the invention, the loading step of the method can include loading the buffer with audio data read from an audio device during a recording operation. In that aspect, the method can further include performing steps (b) through (d) immediately after loading the buffer with the audio data. In yet another aspect of the invention, the loading step of the method can include loading the buffer with audio data to be written to an audio device during a playback operation. In that aspect, the method also can include performing steps (b) through (d) immediately prior to writing the audio data to the audio device.

Importantly, a system and method in accordance with the inventive arrangements can provide a consistent interface and set of requirements that can permit third party developers to distribute FCs in binary form for use by other application developers. The same interface and requirements also can make installation or registration of FCs as simple as possible while providing sufficient flexibility so that FCs are not unduly constrained in their behavior. Moreover, such an interface can allow the installation of FCs in such a way that the FCs are globally installable on an embedded platform for automatic execution by all applications using affected audio devices, and locally installable so that the FCs are executed only by a specific application using a specific audio device. Finally, it is an advantageous feature that such an architecture can be asynchronous, so that the primary thread is not blocked while the audio device is active and the FCs are executing.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a block diagram of an embedded system for processing audio signals.

FIG. 2 is an architecture for use in the embedded system of FIG. 1.

FIG. 3 is a schematic relationship diagram illustrating the interaction between audio filter/controller callback functions and an embedded audio layer in the architecture of FIG. 2.

FIG. 4. is an entity process diagram illustrating the interaction between the audio application and embedded audio layer of FIG. 3, and a spawned thread for applying audio filters and controllers to audio data processed in an audio device.

FIG. 5A is a flow chart illustrating a process for registering a filter/controller callback in the embedded audio layer of FIG. 2.

FIG. 5B is a flow chart illustrating a process for un-registering a filter/controller callback in the embedded audio layer of FIG. 2.

FIG. 6 is a flow chart illustrating a recording process for applying filters and controllers to audio data processed by the embedded audio layer of FIG. 2.

FIG. 7 is a flow chart illustrating a playback process for applying filters and controllers to audio data processed by the embedded audio layer of FIG. 2.

### DETAILED DESCRIPTION OF THE INVENTION

The present invention is a system which can allow the automatic modification of audio data or audio device behavior based on the audio data read from or written to the audio device immediately before or immediately after the processing of the audio data by the audio device. In particular, the system can provide a consistent interface for integrating a filter/controller (FC) with the reading and writing operations of an embedded audio layer (EAL). Once an FC has been registered with the EAL using the present invention, the EAL can automatically call the FC to modify audio data or audio device behavior based on the audio data read from or written to the audio device. Importantly, the EAL can call the registered FC immediately before the writing of audio data to the audio device, or immediately after the reading of audio data from the audio device.

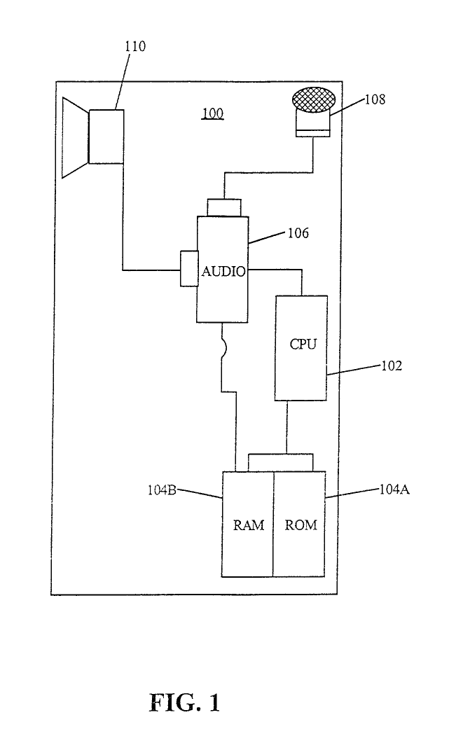

FIG. 1 shows a typical embedded computing device 100 suitable for use with the present invention. The embedded computing device 100 preferably is comprised of a computer including a central processing unit (CPU) 102, one or more memory devices and associated circuitry 104A, 104B. The computing device 100 also includes a microphone 108 and speaker 110, both operatively connected to the computing device through suitable audio interface circuitry 106. The CPU can be comprised of any suitable microprocessor or other electronic processing unit, as is well known to those skilled in the art. Memory devices can include both non-volatile memory 104A and volatile memory 104B. Examples of non-volatile memory can include read-only memory. Examples of non-volatile memory can include random access memory (RAM). The audio interface circuitry 106 can be a conventional audio subsystem for converting both analog audio input signals to digital audio data, and also digital audio data to analog audio output signals.

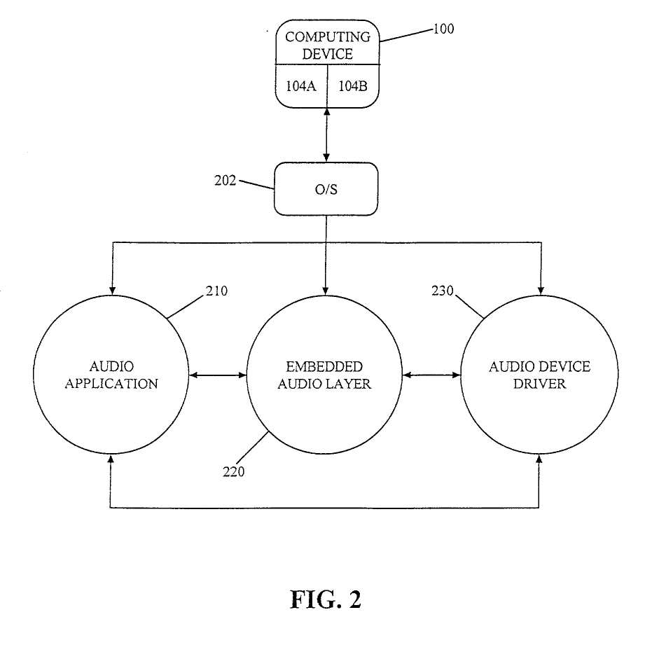

FIG. 2 illustrates a typical architecture for use in the embedded audio system 100 of FIG. 1. As shown in FIG. 2, the architecture can include an operating system 202, an audio application 210, an embedded audio layer (EAL) 220, and an audio device driver 230. The purpose of the EAL 220 is to provide an application programming interface (API) for audio device control that is consistent from audio device to audio device, from embedded system to embedded system. To do so, the EAL 220 acts as an abstraction layer that wraps an embedded system specific audio system interface, thereby shielding the application developer from the differences between embedded systems and audio devices. In FIG. 2, the EAL 220 and audio device driver 230 are shown as separate application programs. It should be noted however, that the invention is not limited in this regard, and these application programs could be implemented as a single, more complex application program.

Referring both to FIGS. 1 and 2, in operation, analog audio signals representative of sound received in microphone 108 are converted to digitized audio data in the embedded audio system 100 using the audio device 106. Subsequently, the digitized audio data can be provided by the audio device 106 to the EAL 220 via the audio device driver 230. The EAL 220, in turn, can provide the digitized audio data to the audio application 210 in which the digitized audio data can be further processed. Similarly, processed digital audio data can be provided by the audio application 210 to the EAL 220. The EAL 220 can provide the processed digital audio data to the audio device 106 via the audio device driver 230. The audio device 106, in turn, can convert the processed digital audio data to analog audio signals and provide the same through the speaker 110.

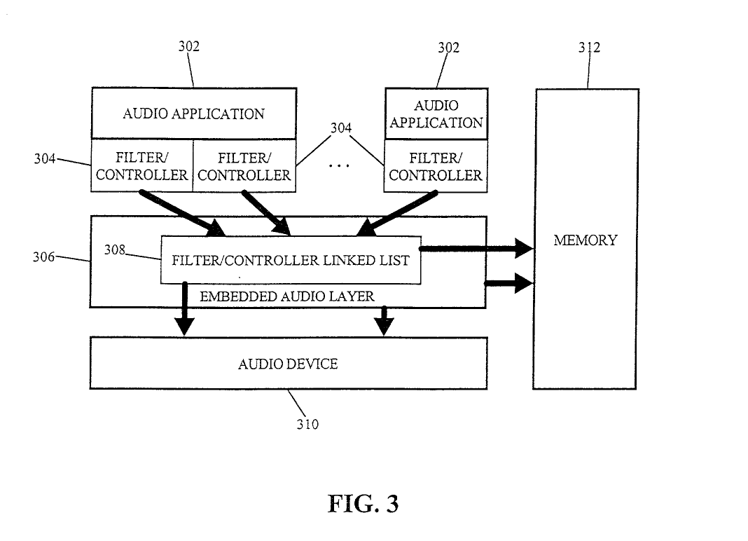

FIG. 3 is a schematic relationship diagram illustrating the interaction between and EAL 306 and audio FCs 304 associated with audio applications 302. An audio FC 304 is one of an audio filter or an audio controller. An audio filter can process audio data. An example of an audio filter is a low-pass filter that eliminates higher frequency content from an audio stream. In contrast, an audio controller can modify device behavior by analyzing audio data and executing EAL functions for controlling the audio device. Unlike filters, controllers do not modify audio data. As shown in FIG. 3, EAL 306 can control the device characteristics of the audio device 310. Moreover, audio data processed by the audio device 310 can be placed in buffers in memory 312 from which the audio data can be processed by the EAL 306.

Notably, the EAL 306 can have associated therewith one or more audio applications 302. Additionally, each audio application 302 can have associated therewith one or more FCs 304. In accordance with the present invention, audio applications 302 can register FCs for processing audio data with the EAL 306. Upon registration, the EAL 306 can insert the FCs into an FC linked list 308. During audio device operations performed by the EAL 306, for instance reading and writing operations, the EAL 306 can cycle through the FC linked list 308 and execute each FC contained therein.

Upon execution, depending upon the EAL operation, each FC 304 in the FC linked list 308 can pre-process or post-process audio data contained in memory 312. Importantly, individual FCs 304 can be enabled or disabled for particular audio devices 310 and EAL operations. In this manner, it is an advantage of the present invention that the FCs 304 can be globally installable in an embedded platform and can be automatically executed by all audio applications 302 using the affected audio devices 310. Furthermore, the FCs 304 can be locally installable so that each FC 304 can be executed only by a specific application 302 using a specific audio device 310.

The EAL 306 is designed to operate asynchronously, returning audio data, status and errors to audio applications from within a separate thread of execution. This information can be returned to audio applications via callback functions. More particularly, the callback functions can be developed by the audio application developer, registered with the EAL 306 and executed by the EAL 306 as required. To allow the convenient and efficient use of FCs, the EAL 306 can be configured to permit the registration of FCs distributed by third party developers. In consequence, third party FC developers can distribute FCs as binary objects, without the need for source code other than header files containing the FC function prototypes. In addition, this configuration can provide a measure of data integrity. By keeping controllers separate from filters, the EAL 306 can check audio data integrity subsequent to the execution of the controller. If the audio data has changed, the associated audio application 302 can be alerted.

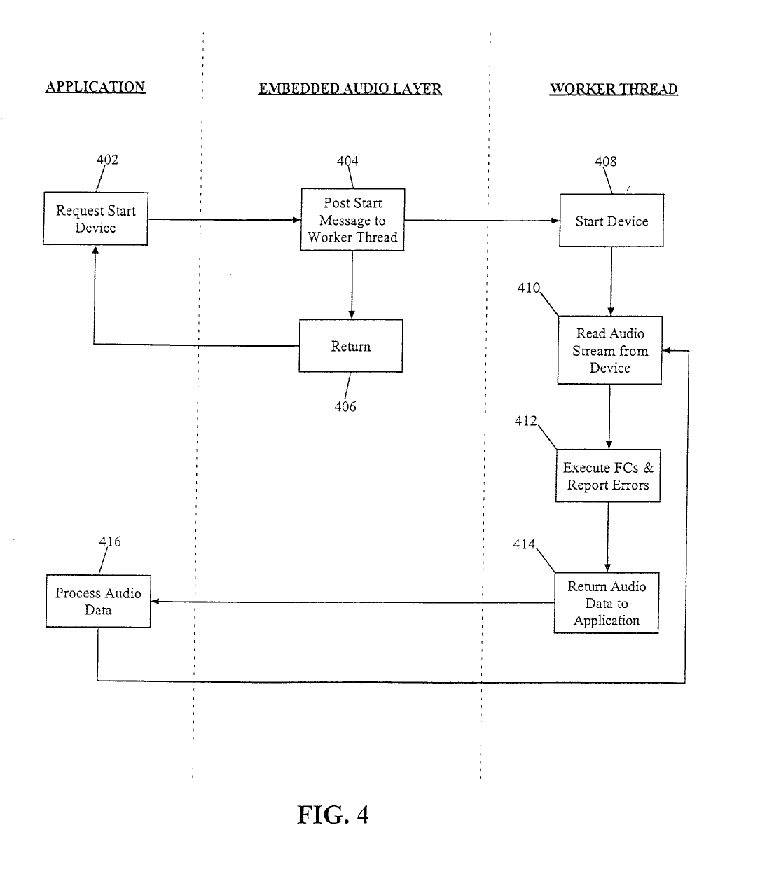

FIG. 4. is an entity process diagram illustrating the interaction between an audio application, an EAL and a spawned thread for applying FCs to audio data processed in an audio device. In step 402, the audio application can request that the audio device initiate an audio data transfer by calling a corresponding EAL function provided by the EAL API. In step 404, the EAL function can post a start message to the worker thread before returning control to the audio application in step 406. In step 408, the worker thread can process the start message and initiate a data transfer. In step 410, the worker thread can receive audio data from the audio device.

Notably, in step 412, FCs contained in the FC linked list of the EAL can be executed. More particularly, when called by the EAL, each FC can perform operations on the audio data or on the audio device as the case may be. Moreover, in the case where FCs can be enabled or disabled for particular operations or audio devices, disabled FCs in the FC linked list can be bypassed by the EAL. Though the invention is not limited in regard to the order in which the FCs are executed, in one embodiment of the invention, the FCs are executed in the order in which the FCs had been registered. Significantly, if during the execution of an FC, the FC reports an error to the EAL, the error can be reported to the associated audio application via an error callback. Moreover, if a controller (and not a filter) modifies the audio data, that too can be reported as an error to the associated audio application.

In step 414, when all of the FCs have either been executed or bypassed, the audio data can be returned to the audio application. In step 416, the audio application can process the audio data. Concurrently during the processing of the audio data by the audio application, in step 410, the worker thread can read the next segment of audio data from the audio device. Subsequently, steps 412, 414 and 416 can be repeated until the audio application requests that the audio device discontinue operation.

As an example, suppose that a third party applications developer wishes to use both an Automatic Gain Controller (AGC) and a built-in phase shift controller (PSC) when recording audio data. Furthermore, suppose the applications developer wishes to use a DC bias filter (DCBF) to remove any DC bias from the recorded audio data and a Noise Injection Filter (NIF) to add white noise to the recorded audio data. Further assume that two buffers—buf1 and buf2—have been registered with the EAL for receiving the audio data from the audio device. Also, assume that the FC callbacks for performing the above functions have been registered in the following order: AGC, DCB, PSC and NIF. Accordingly, the system of the present invention can operate as follows:

| | |
|---|---|
| 1. | buf1 recording is completed by the audio device |
| 2. | Worker thread executes AGC for buf1. |
| 3. | Worker thread executes DCBF for buf1. |
| 4. | Worker thread executes PSC for buf1. |
| 5. | Worker thread executes NiF for buf1. |
| 6. | Return buf1 to the audio application. |
| 7. | buf2 recording is completed by the audio device |
| 8. | Worker thread executes AGC for buf2 |
| 9. | Worker thread executes DCBF for buf2 |
| 10. | Worker thread executes PSC for buf2 |
| 11. | Worker thread executes NIF for buf2 |
| 12. | Return buf2 to the audio application. |

Significantly, it will be apparent to one skilled in the art, that without an FC architecture configured in accordance with the inventive arrangements, a third party audio application developer must write code for passing the audio data received in step 416 to an FC outside the operation of the EAL. This process can be complex, especially if third party application developers have no standard prototype to which they must adhere. In that case, each FC likely can have their own calling conventions, argument lists and return mechanisms for making each FC unique. In consequence, the programming and management of such FCs can be difficult. However, with the FC architecture of the present invention, these problems can be abated first, by calling the FC automatically on behalf of the application developer, second by providing a consistent mechanism for error reporting, and third, by providing a consistent mechanism for registering and un-registering and enabling and disabling FCs.

When filters and controllers are registered with the EAL, the filters and controllers, themselves, can register internal callbacks with the EAL. Attendant to those requirements for registration, execution and error reporting, an API can be provided that allows FC registration, un-registration, enabling, disabling and error reporting. An exemplary API is shown in Appendix A. Note, however, that the API shown in Appendix A is representative only of one embodiment of the invention and does not exclude other equally suitable APIs for providing FC registration, execution and error reporting.

As shown in Appendix A, in one aspect of the present invention, the prototype FCEntry(FCID, FCMsg, void*, void*) denotes the FC entry routine called during registration of an FC, where FCID is an identifier for the FC instance, FCMsg is a parameter denoting whether the FC should be registered or unregistered, and the void pointers are pointers to FCMsg dependent data. CtrlCB denotes the FC callback for a controller. The controller callback can be executed by the EAL when the audio device is active. Similarly, FltrCB is a filter callback that can be executed by the EAL when the audio device is active.

RegisterFC and UnregisterFC can be called by an audio application to register or unregister the FC specified by the FCEntry pointer, pFunc. Similarly, EnableFC and DisableFC can be called by an audio application to enable or disable a registered FC specified by the FCEntry pointer, pFunc. FCErrorCB is an FC error callback. In addition, the function CallFCErrorCB can be executed by the FC when it encounters an error. When executed, the EAL can determine the address of the FCErrorCB routine based on an FCID. Using this address, the EAL can execute the appropriate FCErrorCB routine and can provide suitable parameters to FCErrorCB.

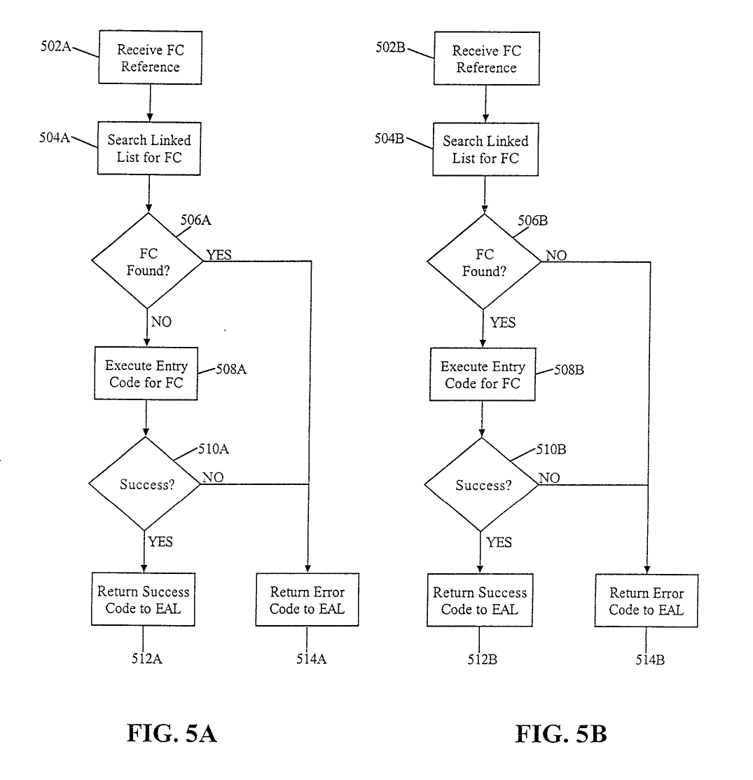

FIG. 5A is a flow chart illustrating a process for registering a filter/controller callback in an EAL. Registration of an FC occurs by calling RegisterFC. The logic contained within RegisterFC begins in step 502A in which an audio application executes the RegisterFC function, passing to it audio device information, the address of FCEntry, pointer registration data, and, optionally, a pointer to the FCErrorCB routine. In step 504A, the EAL can search its Filter/Controller Linked List for the matched pair of FCID and FCEntry. In step 506A, if the match pair is found, then the FCEntry has already been registered for the audio device and, in the case where specific FCEntry may only be registered once with a specific audio device, RegisterFC can return an error code indicating the failure. Otherwise, the process can continue to step 508A.

In step 508A, the EAL can execute the FCEntry routine, passing therein an FCID, a registration message, and pointers to additional registration message data. Notably, where the FC is a filter, the FCEntry routine can place the address of the FltrCB callback and associated callback data in an FCData data structure. FCData denotes the address of a data structure, specified by the EAL and supplied by the EAL to the FC during registration. The FC populates the FCData data structure with a mixture of required and optional data which can be used to execute the appropriate FC callback, e.g. FltrCB and CtrlCB. Likewise, where the FC is a controller, the FCEntry routine can place the address of the CtrlCB callback and associated callback data in an FCData data structure. In any case, if in step 510A the FCEntry routine encounters no errors, in step 512A a success code can be returned to the EAL. In contrast, if in step 510A the FCEntry routine encounters an error, in step 514A an error code can be returned to the EAL.

Notably, if the FCEntry routine reports a success, an FCLLData data structure can be populated with FC related data and inserted into the EAL's Filter/Controller Linked List. The FCLLData data structure can be used by the EAL to indicate to which audio device the FC is associated and under what conditions the FC should be called by the EAL. The FCLLData data structure contains the device information, the address of the FCEntry routine, the address of the corresponding callback and optional callback data, the address of the FCErrorCB callback, the FCID and a boolean flag indicating whether the FC is enabled or disabled. Subsequent to the population of the FCLLData data structure, the RegisterFC function can the FC return code (success or error) to the application.

FIG. 5B is a flow chart illustrating a process for un-registering a filter/controller callback in an EAL. Un-registration of an FC occurs by calling UnregisterFC. The logic contained within UnregisterFC begins in step 502B in which an audio application executes the UnregisterFC function, passing to it device information, the address of FCEntry, and a pointer to un-registration data. In step 504B, the EAL can search its Filter/Controller Linked List for the matched pair of FCID and FCEntry. The matched pair can permit the use of the same FCEntry routine for different audio devices. By using the matched pair, only the reference to FCEntry for the specified audio device can be un-registered. All other instances of FCEntry can remain in the EAL's Filter/Controller Linked List. In step 506B, if the match pair is not found, then the FCEntry has not been registered for the audio device and, in step 514B, UnregisterFC can return an error code indicating the failure. Otherwise, the process can continue to step 508B.

In step 508B, the EAL can execute the FCEntry routine, passing therein an FCID, an un-registration message, and pointers to additional un-registration message data contained in the FCLLData structure. If in step 510B the FCEntry routine encounters no errors, in step 512B a success code can be returned to the EAL. In contrast, if in step 510B the FCEntry routine encounters an error, in step 514B an error code can be returned to the EAL. Notably, if the FCEntry routine reports a success, the FCLLData data structure corresponding to the un-registered FC can be removed from the EAL's Filter/Controller Linked List. Subsequent to the removal of the FCLLData data structure, the UnregisterFC function can the FC return code (success or error) to the audio application.

In one aspect of the present invention, while a particular audio device is active, FCs registered for the device can be executed in the order in which they were registered. Still, in this aspect of the invention, only those FCs which are enabled are executed. Those FCs which have disabled are bypassed. FCs can be enabled or disabled when an audio application calls the EnableFC or DisableFC functions, respectively. When executed, the functions can traverse the Filter/Controller Linked List, searching for the matched pair of an FCEntry address and audio device identifier. Once found, the functions can set a boolean enable or disable flag in the FCLLData data structure.

The execution of the FCs can be accomplished by traversing the EAL's Filter/Controller Linked List, obtaining the data from each FCLLData data structure and determining if the FC is registered for the active audio device. During a recording operation, FCs are executed after audio data has been read from the audio device. During playback, FCs are executed before audio data has been written to the audio device. The distinction between the recording and playback sequences exist because audio data is not valid for recorders until the audio data has been read from the audio device. Therefore, recorder FCs are considered post-processors of audio data, while playback FC are considered pre-processors of audio data.

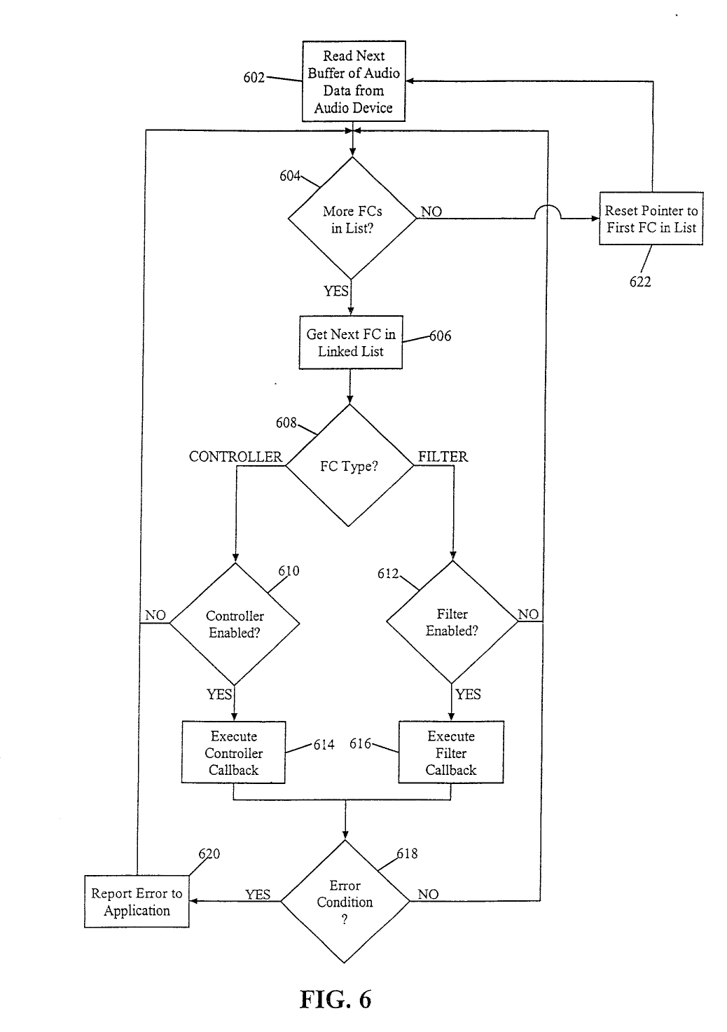

FIG. 6 is a flow chart illustrating a process for applying recorder FCs to audio data processed by an EAL. Beginning in step 602, the EAL can read a buffer of audio data from an audio device. Subsequently, the EAL can traverse its Filter/Controller Linked List beginning at the first FC in the list searching for the next FC registered with the audio device. If, in step 604, no more FCs are found, in step 622, a pointer to the current FC in the Filter/Controller Linked List can be reset to the first FC in the list and the next buffer of audio data can be read from the audio device. Otherwise, the next FC can be retrieved from the Filter/Controller Linked List in step 606.

If in step 608, the FC is identified as a filter, in step 612 it can be determined if the filter is enabled. If the filter is not enabled, the filter can be bypassed and the process can return to step 604. Conversely, if the filter is enabled, in step 616 the EAL can execute the filter callback, passing thereto the buffer, the buffer length, the format of the buffer and the filter callback data registered with the filter. Notably, if the buffer is the last in a contiguous stream of buffers, the EAL can call the filter callback with a flag indicating that fact. (The EAL allows the registration of multiple buffers.) This allows the filter to perform any activity related to the cessation of the current stream of buffers or in preparation for another audio data stream.

By comparison, if in step 608, the FC is identified as a controller, in step 610 it can be determined if the controller is enabled. If the controller is not enabled, the controller can be bypassed and the process can return to step 604. Conversely, if the controller is enabled, in step 614 the EAL can execute the controller callback passing thereto the audio device information, the buffer, the buffer length, the audio format of the buffer and the controller callback data registered with the controller. Notably, as in the case of a filter, if the buffer is the last in a contiguous stream of buffers, the EAL can call the controller callback with a flag indicating that fact.

In step 618, if the filter or controller callback returns an error code to the EAL, or if the controller modifies the buffer data, in step 620 the EAL can report an error to the associated audio application. In addition, the EAL can provide to the associated audio application the address of the offending FCEntry routine. In either event, the process can return to step 604, in which the Filter/Controller Linked List can be searched for the next FC registered for the audio device. If another FC is found the process can repeat. Otherwise, the traversal of the Filter/Controller will have completed and the next buffer of audio data can be read from the device.

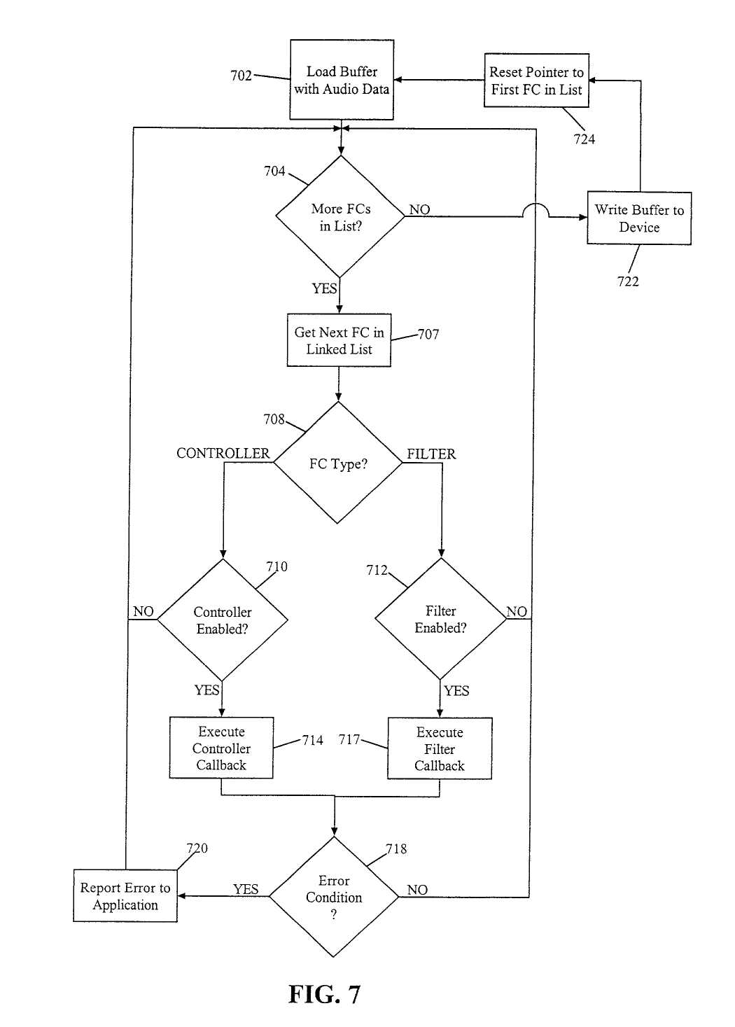

FIG. 7 is a flow chart illustrating a process for applying playback FCs to audio data processed by an EAL. Beginning in step 702, the EAL can load a buffer with audio data destined to an audio device. Subsequently, the EAL can traverse its Filter/Controller Linked List beginning at the first FC in the list searching for the next FC registered with the audio device. If, in step 704, no more FCs are found, in step 722, the buffer can be written to the audio device. Otherwise, the next FC can be retrieved from the Filter/Controller Linked List in step 707.

If in step 708, the FC is identified as a filter, in step 712 it can be determined if the filter is enabled. If the filter is not enabled, the filter can be bypassed and the process can return to step 704. Conversely, if the filter is enabled, in step 717 the EAL can execute the filter callback, passing thereto the buffer, the buffer length, the format of the buffer and the filter callback data registered with the filter. Notably, if the buffer is the last in a contiguous stream of buffers, the EAL can call the filter callback with a flag indicating that fact.

By comparison, if in step 708, the FC is identified as a controller, in step 710 it can be determined if the controller is enabled. If the controller is not enabled, the controller can be bypassed and the process can return to step 704. Conversely, if the controller is enabled, in step 714 the EAL can execute the controller callback passing thereto the audio device information, the buffer, the buffer length, the audio format of the buffer and the controller callback data registered with the controller. Notably, as in the case of a filter, if the buffer is the last in a contiguous stream of buffers, the EAL can call the controller callback with a flag indicating that fact.

In step 718, if the filter or controller callback returns an error code to the EAL, or if the controller modifies the buffer data, in step 720 the EAL can report an error to the associated audio application. In addition, the EAL can provide to the associated audio application the address of the offending FCEntry routine. In either event, the process can return to step 704, in which the Filter/Controller Linked List can be searched for the next FC registered for the audio device. If another FC is found the process can repeat. Otherwise, the traversal of the Filter/Controller will have completed, the buffer can be written to the audio device in step 722, and the next buffer of audio data can be loaded.

Notably, the present invention can be realized in hardware, software, or a combination of hardware and software. The method of the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which when loaded in a computer system is able to carry out these methods. Computer program means or computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

### Appendix A

/**The following prototype defines an exemplary FC entry routine that can be executed
by an EAL during registration. It can be implemented by a third party FC developer
according to the prototype and the behavior required by the EAL. It can be called by
the EAL API function “Register_FC”. If the function parameter “msg” is a registration
message, then the parameter “param1” contains the address of an FC data structure
and param2 contains the address of an FC-defined registration data structure. In
contrast, if the msg parameter contains an un-registration message, the param1 is
NULL and param2 contains the address of an FC defined un-registration data
structure.**/

| typedef unsigned long FCEntry( FCID | | fcID, /* Identifier for FC instance*/ | |
|---|---|---|---|
| | FCMsg | msg, /* Register or Unregister. | */ |
| | void | *param1, /* msg dependent data. | */ |
| | void | *param2);/* msg dependent data. | */ |

/** RegisterFC is called by the application to register the FC specified by pFunc. **/

| int RegisterFC( | DevInfo | devInfo, | /* Device for which FC is registered. | */ |
|---|---|---|---|---|
| | void | *Func, | /* Address of the FC entry routine. | */ |
| | void | *pRegData, | /* Registration data defined by FC dev.*/ | |
| | FCErrorCB | *pErrorCB ); | /* Address of FCError callback | */ |

/ ** UnregisterFC is called by the application to unregister the FC specified by pFunc. **/

| int UnregisterFC( | DevInfo | devInfo, | /* Device for which FC is registered. | */ |
|---|---|---|---|---|
| | FCEntry | *pFunc, | /* Address of the FC entry routine. | */ |

| | | |
|---|---|---|
| void *pUnregData); | /* Unregistration data defined by FC dev | */ |

/** EnableFC is called by the application to enable a registered. **/

| int EnableFC( DevInfo | | devInfo, | /* Device for which the FC is registered. | */ |
|---|---|---|---|---|
| | FCEntry | *pFunc); | /* Address of the FC entry routine. | */ |

/** DisableFC is called by the application to disable a registered. **/

| int DisableFC( DevInfo | | devInfo, | /* Device for which the FC is registered. | */ |
|---|---|---|---|---|
| | FCEntry | *pFunc); | /* Address of the FC entry routine. | */ |

/** The following function prototype defines an FC error callback that can be optionally
implemented by the application developer and registered via RegisterFC. **/
typedef void FCErrorCB

| | | | |
|---|---|---|---|
| ( DevInfo | devInfo, | /* Device information for which the FC is registered. | */ |

| | | | |
|---|---|---|---|
| void | *pFCErrorData); | /* Address of error data defined by FC dev. | */ |

/** The following function can be executed by the FC when it encounters an error.
When executed, the EAL can determine the address of the FCErrorCB based on the
FCID in order to execute the FCErrorCB and to provide the corresponding parameters
to FCErrorCB. **/

| | | | | |
|---|---|---|---|---|
| int CallFCErrorCB( | FCID | fcID, | /* Unique identifier for the FC instance. | */ |

| | | |
|---|---|---|
| void | *pFCErrorData ); /* Address of error data | */ |

/** The following function prototype defines a controller callback that can be executed
by the EAL when a device is active. Controller manufacturers must implement the
callback according to the prototype. **/

| typedef int CtrlCB( FCID | | fcID, | /* Unique identifier for the FC instance. | */ |
|---|---|---|---|---|
| | const unsigned char | *pBuf, | /* Address of audio data buffer. | */ |
| | unsigned long | length, | /* The length of the audio data. | */ |
| | AudioFormat | format, | /* The format of the audio data. | */ |
| | | | /* (Samples per second, | */ |
| | | | /* bits per sample, and | */ |
| | | | /* number of channels. | */ |
| | DevInfo | devInfo | /* Device information. | */ |
| | unsigned long | flags, | /* Secondary info about data/device. | */ |

| | | |
|---|---|---|
| void | *pFCCBData ); /* Address of data structure | */ |

| | |
|---|---|
| /* provided by FAC to EAL | */ |
| /* during FC registration. | */ |

/** The following function prototype can define a filter callback that is executed by the
EAL when a device is active. Filter developers can implement the callback according to
the prototype. **/

| typedef int FltrCB( FCID | | fcID, | /* Unique identifier for the FC instance. | */ |
|---|---|---|---|---|
| | const unsigned char | *pBuf, | /* Address of audio data buffer. | */ |
| | unsigned long | length, | /* The length of the audio data. | */ |
| | AudioFormat | format, | /* The format of the audio data. | */ |
| | | | /* (Samples per second, | */ |
| | | | /* bits per sample, and | */ |
| | | | /* number of channels. | */ |
| | unsigned long | flags, | /* Secondary info about data/device. | */ |

| | | |
|---|---|---|
| void | *pFCCBData ); /* Address of data structure | */ |

| | |
|---|---|
| /* provided by FAC to EAL | */ |
| /* during FC registration. | */ |

1. A system configured to automatically modify audio data and audio device behavior comprising:
an embedded audio layer (EAL), said EAL providing an abstracted interface to an audio device;
a filter/controller linked list accessible by said EAL; and,
a registration processor for registering filter/controllers (FCs) with said EAL, said registration processor inserting an FC reference into said filter/controller linked list upon registration of a corresponding FC.

2. The system of claim 1, further comprising:
an unregistration processor for unregistering FCs with said EAL, said unregistration processor removing an FC reference from said filter/controller linked list upon unregistration of a corresponding FC.

3. The system of claim 2, further comprising:
an enablement processor for enabling use of a corresponding FC when a specified audio device is active; and,
a disablement processor for disabling use of an enabled FC when a specified audio device is active.

4. A system for automatically modifying audio data and audio device behavior comprising:
an embedded audio layer (EAL); and,
at least one filter/controller (FC) registered with said EAL for automatically modifying audio data and audio device behavior.

5. The system of claim 4, wherein said at least one FC is an audio filter programmed to modify audio data.

6. The system of claim 4, wherein said at least one FC is an audio device controller programmed to modify audio device behavior.

7. The system of claim 4, further comprising:
a filter/controller linked list containing a reference to said at least one registered FC.

8. The system of claim 7, wherein each reference in said filter/controller linked list is a filter/controller linked list data structure comprising an address to a callback to a corresponding registered FC.

9. The system of claim 8, wherein said filter/controller linked list data structure further comprises an address to a callback to an error handling routine associated with said corresponding registered FC.

10. The system of claim 8, wherein said filter/controller linked list data structure further comprises a flag indicating whether said FC is enabled or disabled.

11. A filter/controller (FC) configured for integration with an embedded audio layer (EAL) comprising:
an entry routine for managing registration and unregistration of the FC;
a registration routine for registering the FC with the EAL;
an unregistration routine for un-registering the FC with the EAL; and,
an FC callback for performing one of modifying audio data and modifying audio device behavior.

12. The FC of claim 11, further comprising:
an error handling callback for handling errors encountered by the FC.

13. The FC of claim 11, further comprising:
an enablement routine for enabling the FC when registered; and,
a disablement routine for disabling an enabled FC.

14. A method for configuring an embedded audio layer (EAL) to automatically modify audio data and audio device behavior comprising:
receiving a filter/controller (FC) reference in the EAL;
searching a filter/controller linked list for said FC reference; and,
if said FC reference is not found in said filter/controller linked list, inserting a reference to said FC in said filter/controller linked list, said inserted reference comprising at least pointer to a callback associated with said FC.

15. The method of claim 14, wherein said step of searching said filter/controller linked list for said FC reference comprises:
searching said filter/controller linked list for a match pair comprising an FC identifier for an instance of an FC associated with said reference, and an address for an FC entry routine associated with said reference.

16. A method for automatically modifying audio data and audio device behavior comprising:
(a) loading a buffer with audio data;
(b) retrieving a filter/controller (FC) from a filter/controller linked list in an embedded audio layer (EAL);
(c) executing an FC callback associated with said retrieved FC; and,
(d) repeating steps (b) and (c) for each FC in said filter controller linked list.

17. The method of claim 16, further comprising:
reloading said buffer with more audio data; and,
repeating steps (b) through (d) for said reloaded buffer.

18. The method of claim 16, further comprising:
determining whether said FC is an audio filter or an audio controller.

19. The method of claim 18, wherein said executing step comprises:
if said FC is an audio filter, executing an audio filter callback, said audio filter callback modifying said audio data in said buffer.

20. The method of claim 18, wherein said executing step comprises:
if said FC is an audio controller, executing an audio controller callback, said audio controller callback modifying audio device behavior of a specified audio device.

21. The method of claim 16, further comprising:
determining whether said FC is enabled; and,
performing said executing step only if said FC is enabled.

22. The method of claim 16, wherein said loading step comprises:
loading said buffer with audio data read from an audio device during a recording operation.

23. The method of claim 22, further comprising:
performing steps (b) through (d) immediately after loading said buffer with said audio data.

24. A machine readable storage, having stored thereon a computer program for configuring an embedded audio layer (EAL) to automatically modify audio data and audio device behavior, said computer program having a plurality of code sections executable by a machine for causing the machine to perform the steps of:
receiving a filter/controller (FC) reference in the EAL;
searching a filter/controller linked list for said FC reference; and,
if said FC reference is not found in said filter/controller linked list, inserting a reference to said FC in said filter/controller linked list, said inserted reference comprising at least pointer to a callback associated with said FC.

25. The machine readable storage of claim 24, wherein said step of searching said filter/controller linked list for said FC reference comprises:
searching said filter/controller linked list for a match pair comprising an FC identifier for an instance of an FC associated with said reference, and an address for an FC entry routine associated with said reference.

26. A machine readable storage, having stored thereon a computer program for automatically modifying audio data and audio device behavior, said computer program having a plurality of code sections executable by a machine for causing the machine to perform the steps of:
(a) loading a buffer with audio data;
(b) retrieving a filter/controller (FC) from a filter/controller linked list in an embedded audio layer (EAL);
(c) executing an FC callback associated with said retrieved FC; and,
(d) repeating steps (b) and (c) for each FC in said filter controller linked list.

27. The machine readable storage of claim 26, further comprising:
reloading said buffer with more audio data; and,
repeating steps (b) through (d) for said reloaded buffer.

28. The machine readable storage of claim 26, further comprising:
determining whether said FC is an audio filter or an audio controller.

29. The machine readable storage of claim 28, wherein said executing step comprises:
if said FC is an audio filter, executing an audio filter callback, said audio filter callback modifying said audio data in said buffer.

30. The machine readable storage of claim 28, wherein said executing step comprises:
if said FC is an audio controller, executing an audio controller callback, said audio controller callback modifying audio device behavior of a specified audio device.

31. The machine readable storage of claim 26, further comprising:
determining whether said FC is enabled; and,
performing said executing step only if said FC is enabled.

32. The machine readable storage of claim 26, wherein said loading step comprises:
loading said buffer with audio data read from an audio device during a recording operation.

33. The machine readable storage of claim 32, further comprising:
performing steps (b) through (d) immediately after loading said buffer with said audio data.

34. The machine readable storage of claim 26, wherein said loading step comprises:
loading said buffer with audio data to be written to an audio device during a playback operation.

35. The machine readable storage of claim 34, further comprising:
performing steps (b) through (d) immediately prior to writing said audio data to said audio device.
